(19) United States
(12) Patent Application Publication
(10) Pub. No.: US 2006/0243651 A1
(43) Pub. Date: Nov. 2, 2006

(54) Multi-velocity fluid channels in analytical instruments

(76) Inventor: Robert Dallas Ricker, Middletown, DE (US)

Correspondence Address: AGILENT TECHNOLOGIES INC.;INTELLECTUAL PROPERTY ADMINISTRATION, LEGAL DEPT,, M/S DU404, P.O. BOX 7599, LOVELAND, CO, 80537-0599, US

(21) Appl. No.: 11/119,686

(22) Filed: May 2, 2005

(51) Int. Cl. B01D 15/08

(52) U.S. Cl. 210/198.2; 422/70

(57) ABSTRACT

The present invention is directed to a chromatographic separation system, separation unit, and method of use thereof. A separation unit comprises two or more regions, each region having a different cross-sectional area. The separation unit includes single column and multiple column configurations. The invention is also directed to an embodiment of a separation unit containing a solid stationary phase for chromatographic separation, the separation unit comprising two or more contiguous regions, wherein each region has a unique cross-sectional area.

### BACKGROUND

Optimization of separation to achieve the highest possible resolution in the shortest possible elapsed time is a goal for any chromatographic separation. The resolution Rs of a column provides a quantitative measure of its ability to separate two analytes. A chromatographic separation is optimized by varying parameters until the components of a sample mixture are separated cleanly with a minimum expenditure of time.

One method to estimate or calculate resolution is by the Fundamental Resolution Equation, provided below:

$$Rs = \frac{\sqrt{N}}{4} \cdot ( α - 1 ) \cdot \frac{{k}^{′}}{{k}^{′} + 1} \qquad Eq . 1$$

wherein N is the number of theoretical plates making up the column, α is the selectivity factor and k′ is the capacity factor. The first term is related to the kinetic effects that lead to band broadening. The second and third terms are related to the thermodynamics of the constituents (analytes) being separated—that is, to the relative magnitude of their distribution coefficients and the volumes of the mobile and stationary phases. The selectivity factor depends solely upon the properties of the two analytes. The third term depends upon the properties of both the analyte and the column. Fundamental parameters, α, k′ and N can be adjusted to optimize separation performance.

One method of increasing resolution is to increase the number of theoretical plates by increasing the length of the column. However, this method of increasing resolution creates minimal increases in resolution, but is usually expensive in terms of increased run time required for separation. Often resolution can be improved by manipulation of the capacity factor k′, but also usually at the expense of elution time. Similarly, it is generally difficult to reduce run time of a separation system without also decreasing resolution.

Further improvements in chromatography are desired to optimize resolution of components and/or improve run time, with concurrent minimization of negative effects such as increased run time, decreased analyte separation, band broadening, and reduced column capacity.

### SUMMARY

The invention is directed to units, systems, and methods for chromatographic separations. The systems employ one or more separation units for supporting a solid stationary phase wherein each separation unit comprises a combination of two or more regions of different diameter or cross-sectional area.

Embodiments of the invention also include a separation unit containing a solid stationary phase for chromatographic separation, the separation unit comprising a combination of two or more regions of unique cross-sectional area. Some embodiments of the invention may also include a system for chromatographic separation of two or more components of a sample, having a separation unit including two or more regions connected in series, each region, having a uniform cross-sectional area, and at least each region comprising a cross-sectional area different from the cross-sectional area of at least one adjacent region. The present invention is also directed to a methods for using the chromatographic separation units and systems.

### BRIEF DESCRIPTION OF THE DRAWINGS

FIG. 1 is a perspective view of an embodiment of a separation unit with portions cut-away to expose the solid phase material.

FIG. 2 is a perspective view of an additional embodiment of a separation unit presented in a single column configuration.

FIG. 3 is a perspective view of another embodiment of a separation unit.

FIG. 4 is a perspective view of another embodiment of a separation unit.

FIG. 5 is a schematic representation of a chromatographic system.

FIG. 6 is a chromatogram of an isocratic separation of small molecules by a separation unit having multiple regions.

FIG. 7 is a chromatogram of a control isocratic separation of small molecules.

FIG. 8 is a chromatogram of a control isocratic separation of small molecules.

FIG. 9 is a chromatogram of a gradient separation of small molecules by a separation unit having multiple regions.

FIG. 10 is a chromatogram of a control gradient separation of small molecules.

FIG. 11 is a chromatogram of a gradient separation of biological molecules by a separation unit having multiple regions.

FIG. 12 is a chromatogram of a control gradient separation of biological molecules.

### DETAILED DESCRIPTION OF THE PREFERRED EMBODIMENTS

Various embodiments of the present invention will be described in detail with reference to the drawings, wherein like reference numerals represent like parts throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The present invention is directed to chromatographic separation units, systems, and methods employing a separation unit comprising a combination of two or more regions of different diameter or cross-sectional area. Chromatographic separation methods employing a separation unit comprising a combination of two or more regions of different diameter or cross-sectional area may be employed, for example, to optimize resolution of separation of two or more analytes, decrease overall run time for separation, and/or increase quantity of loadable sample. Separation units comprising a combination of two or more regions of different cross-sectional area are also referred to as multi-velocity fluid channels.

The chromatographic separation units, system, and method are applicable to analytical instrumentation employing chromatographic principles, including for example, column and planar chromatography. The chromatographic separation units, system, and method invention are described herein in the context of high performance liquid chromatography (HPLC). However, the units, system and method are applicable across other chromatographic methods including, but not limited to, gas chromatography (GC), liquid chromatography (LC), supercritical fluid chromatography (SFC), open-face chromatography, capillary electrochromatography (CEC), microfluidic chips (e.g., HPLC-chips), and detection cells. The dimensional relationships described herein are useful to design and utilize separation units of all sizes, in nano-, capillary-, and micro-scale analytical separation systems to larger preparatory scale and preparative industrial scale separation systems and methods.

In an embodiment, a separation unit comprises two or more regions wherein each region has a unique, internal cross-sectional area. In an embodiment, each region contains solid stationary phase. A unique cross-sectional area refers to each region having a substantially uniform internal cross-sectional area that differs from the one or more other regions in the separation unit.

In an embodiment, the change in cross-sectional area from a first region to a second region changes the linear velocity of the mobile phase (and analytes) through the second region as compared to the first region. In an embodiment, the cross-sectional area of the first region is smaller than the cross-sectional area of the second region. In another embodiment, the cross-sectional area of the first region is larger than the cross-sectional area of the second region. In a further embodiment, the change from larger cross-sectional area within the first region to small cross-sectional area in the second region causes an increase in linear velocity of the mobile phase (and analytes) moving through the second region.

In an embodiment, the relative size of two or more regions is described by ratios of the cross-sectional areas of adjacent regions within a separation unit. In an embodiment, the cross-sectional area refers to a cross-section of the solid stationary phase contained within a region. In an embodiment, a ratio of XA₁ to XA₂ for a separation unit 10 is greater than 1. In a further embodiment, a ratio of XA₁ to XA₂ is greater than 1:1, but less than or equal to about 5:1. In a further embodiment, a ratio of XA₁ to XA₂ is within a range from about 1.25:1 to about 4:1. In a further embodiment, a ratio of XA₁ to XA₂ is within a range from about 1.5:1 to about 3:1. In a further embodiment, a ratio of XA₁ to XA₂ is within a range from about 1.5:1 to about 2.5:1. In a still further embodiment, a ratio of XA₁ to XA₂ is about 2:1. In embodiments wherein a separation unit comprises three or more regions, ratios of cross-sectional areas are applied to any two adjacent regions.

In an embodiment, the cross-sectional area within a region has a circular or non-circular shape. In a further embodiment, one or more regions have a circular cross-sectional shape. In a still further embodiment, the separation unit comprises regions having a circular cross-sectional shape. Embodiments including separation units having circular cross-sectional shape may be described by either XA or by diameter, D. Area and diameter are directly related for circular cross-sectional shape. Accordingly, the ratios of XA provided above are also directly applicable to ratios of diameters for separation units, regions and solid stationary phases having circular cross-sectional shape.

In an embodiment, optimization of separation is achieved through preliminary separation of compounds in a first region, before entering a second region. In a further embodiment, optimization of separation is achieved through at least partial separation of compounds in a first region having larger XA, before entering a second region having smaller XA for further separation. In another embodiment, optimization of separation is achieved through at least partial separation of compounds in a first region having smaller XA, before entering a second region having larger XA for further separation.

In an embodiment, cross-sectional area of the separation unit is selected based upon quantity of sample (i.e. load) to be separated. In an embodiment, load of a separation system and separation unit is improved by including a first region having larger cross-sectional area. A region with larger cross-sectional area can be loaded with a larger mass of sample compared to a region with smaller cross-sectional area. In an embodiment, a larger amount of sample is loaded into a first larger XA region for at least partial separation of analytes. By achieving at least partial separation of analytes in the first larger XA region, a reduced sample mass (e.g., individual analytes) enter a second smaller XA region at different times for further separation. In a further embodiment, the quantity of sample separated by a separation unit comprising a larger first XA region and a smaller second XA region is larger than can be separated by a control column equivalent to the smaller second XA region alone because of overloading.

The total length of a separation unit or region thereof is selected according to particular use and also varies between types of chromatography. Generally, a separation unit is of sufficient length to achieve separation of the analytes. The region lengths are added together to give a total separation unit length. The choice of separation unit length is balanced with considerations of overall run time. In an embodiment, the length of a separation unit is between approximately 1-100 meters. In a further embodiment, the separation unit is between approximately 1-10 meters. In an embodiment, the separation unit is used for gas chromatography. In an embodiment, the total length of a separation unit is between approximately 10-100 centimeters. In a further embodiment, the total length of a separation unit is between approximately 1-10 centimeters. In an embodiment, the separation unit is used for liquid chromatography, including but not limited to high pressure liquid chromatography. In an embodiment, the total length of a spearation unit is less than 5 centimeters. In an embodiment, the separation unit is used for micro-fluidic chips or detection cells. In various embodiments, the length of a region is approximately within the ranges given above for separation units.

In an embodiment, the length of two or more regions are approximately equivalent. In an embodiment, each region is approximately one half of a separation unit. The length of each region and total length of each separation unit is typically measured by the approximate length of the space occupied or to be occupied by solid phase packing. Portions of the separation units comprising couplers or other connective means are not included in length.

In an alternative embodiment, the length of the regions is not equivalent. For example, the length of a first region can be selected to provide separation of analytes such that each analyte individually enters a second region for further separation. In an embodiment, a separation unit comprises a shorter first region and a longer second region. In another embodiment, a separation unit comprises a longer first region and a shorter second region.

In an embodiment, each region contains solid stationary phase described by, for example, but not limited to: particle size, porosity and chemical composition. In an embodiment, the particle size of the solid stationary phase is different between two or more regions. In an embodiment, a first region has solid stationary phase with a first particle size and a second region has solid stationary phase with a second particle size and/or porosity smaller than the first particle size. In an embodiment, at least one region includes a more retentive bonded phase.

In an embodiment, the particle size is decreased in one or more regions to reduce sensitivity to flow rate. In an embodiment, the particle size of the solid stationary phase is reduced in a second region to increase theoretical plates of the second region. In some uses, the increase in linear velocity of the mobile phase may potentially cause a loss of theoretical plates. In an embodiment, an apparent or estimated reduction in theoretical plates is compensated for by reducing the particle size of the solid stationary phase in the second region. In an embodiment, the particle size is decreased in one or more regions to compensate for loss of theoretical plates when using short region lengths.

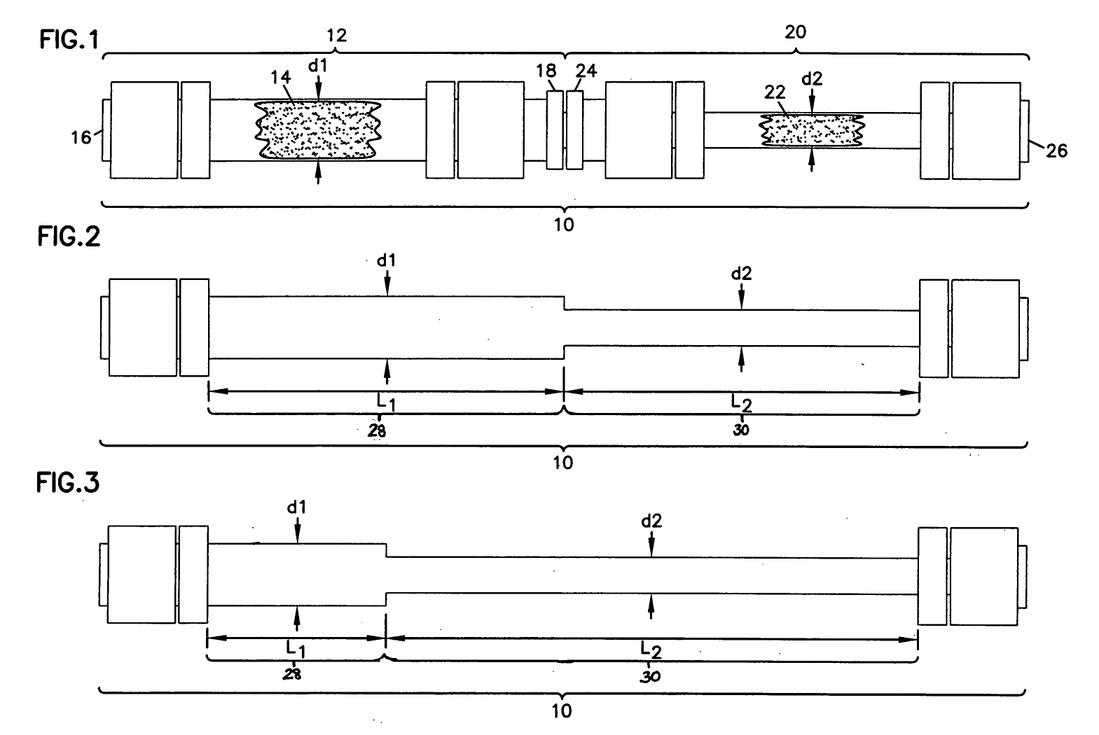

In an embodiment, a separation unit includes two regions in a multiple column configuration. In multiple column configurations each region is a column. A further embodiment of a separation unit is illustrated in FIG. 1. In FIG. 1, separation unit 10 includes two regions, 12 and 20, in a multiple column configuration. Separation unit 10 includes first column 12 and second column 20. First column 12 contains a solid stationary phase 14. First column 12 has an internal diameter D₁ and column length L₁, extending approximately from inlet 16 to outlet 18. Second column 20 contains a solid stationary phase 22. Second column 20 has an internal diameter D₂ and column length L₂, extending approximately from an inlet 24 to an outlet 26. Outlet 18 of first column 12 is connected to inlet 24 of second column 20. The diameter of first column 12, D₁, is greater than the diameter of second column 20, D₂.

In another embodiment, a separation unit 10 has a single column configuration. In this configuration, the separation unit comprises two or more regions of different diameter or cross-sectional area, wherein a separation unit is a single column. In a further embodiment, a separation unit with single column configuration is illustrated in FIG. 2. In FIG. 2, separation unit 10 comprises two regions: first contiguous region 28 having diameter D₁ and second contiguous region 30 having diameter D₂. In separation unit 10 of FIG. 2, first contiguous region 28 is directly connected to second contiguous region 30 and D₁ is greater than D₂.

In another embodiment, a separation unit comprises a shorter first region and a longer second region. In a further embodiment, a separation unit 10 comprises a first contiguous region 28 that is shorter than second contiguous region 30 as shown in FIG. 3. The separation unit 10 of FIG. 3 has single column configuration. In additional embodiments, separation units comprising a shorter first region and a longer second region are formed in multiple column configurations.

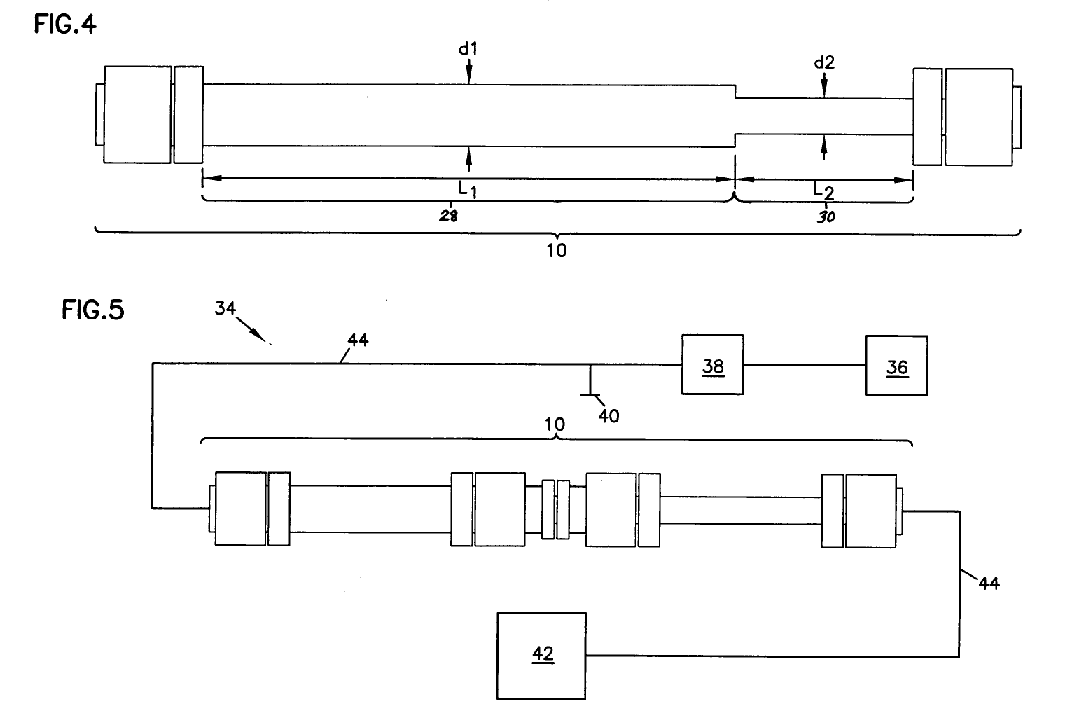

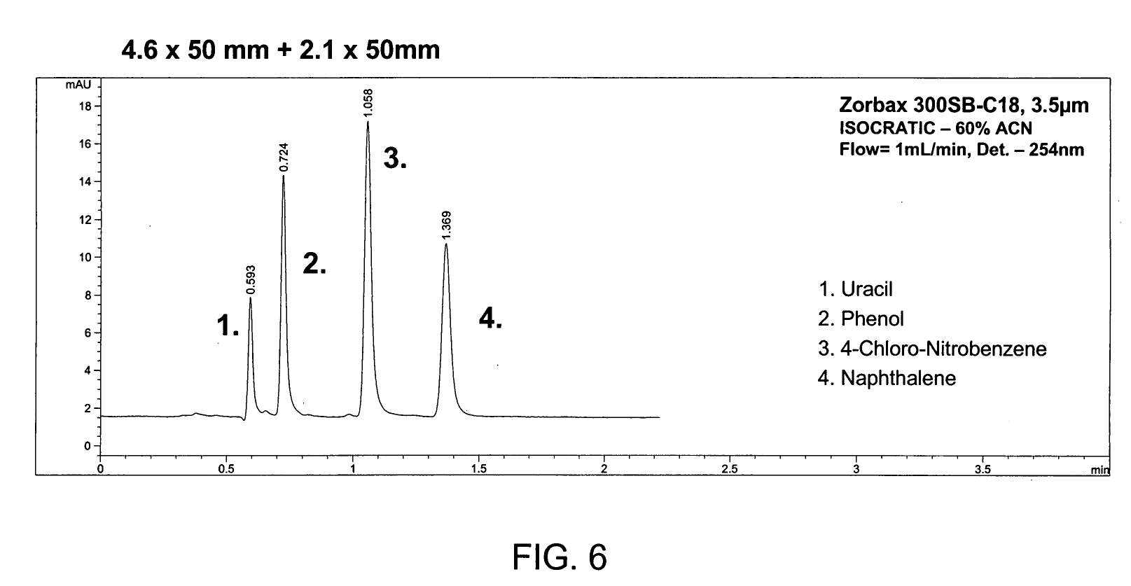

In another embodiment, a separation unit includes a longer first region and a shorter second region. In a further embodiment, an example is shown in FIG. 4, where separation unit 10 includes first contiguous region 28 that is longer than second contiguous region 30. In additional embodiments, separation units include a longer first region and a shorter second region in a multiple column configuration.

One embodiment of a column chromatographic system is illustrated in FIG. 5. The system 34 comprises a separation unit 10, mobile phase source 36, a pump 38, a sample injection port/valve 40, and a detector 42. The components are connected either directly to one another or indirectly by connection tubing 44. Mobile phase from source 36 flows through system 34 by action of pump 38. Sample is applied to the system for chromatographic analysis at sample injection port/valve 40. Mobile phase mixes with the sample and carries it to and through separation unit 10 to detector 42. Within separation unit 10, the sample, carried by the mobile phase, interacts with a solid stationary phase (not shown). The analytes contained in the sample partition between the mobile phase and solid stationary phase resulting in different migration rates through the separation unit 10. In successful chromatographic separations, the analytes of interest are sufficiently separated to allow individual detection and/or collection upon exiting separation unit 10.

In an embodiment, a separation system includes additional component or components. In an embodiment, a separation system additionally includes components for dissolving or diluting samples with a mobile phase and loading samples onto the separation unit. In an embodiment, samples are introduced into a separation system by manual injection. In another embodiment, samples are introduced into a separation system by automated means, for example by autosampler components. In an embodiment, other components include, but are not limited to: components for sparging, filtering, mixing, heating, or otherwise modifying or monitoring the mobile phase. In an embodiment, other components include, but are not limited to: components for heating, cooling or otherwise controlling the column environment.

In an embodiment, a separation system includes a detection component. In a further embodiment, detection components include variable and multi-wavelength detectors, diode array detectors, fluorescence detectors, refractive index detectors, and mass spectrophotometers. In an embodiment, a detection components also includes means for data collection, for example, data recorders. In an embodiment, analog to digital converters and components for data analysis are included in a separation system. In an embodiment, a separation system is connected to a computer to provide either or both data collection and analysis, and operating control of system. In an embodiment, detection may also be coordinated with collection of elutants (analytes) after separation by a separation unit. In an embodiment, preparative methods collect mobile phase fractions containing the analyte of interest and recover of the analyte from the mobile phase.

In an embodiment, a separation system includes additional components for performance of a particular chromatographic method. In a further embodiment, the particular chromatographic method includes liquid chromatography (LC) and high performance liquid chromatography (HPLC), gas chromatography (GC), supercritical fluid chromatography (SFC), open-face chromatography, capillary electrochromatography (CEC), micro-fluidic chips (HPLC-chips), and detection cells. In an embodiment, a wide variety of pumping mechanisms are included for liquid and high pressure liquid chromatography. In a further embodiment, other components include, but are not limited to: pulse dampers, back pressure regulators and pressure transducers. In an embodiment for a GC separation system, components include, but are not limited to: gas pressure regulators, flow controllers and column ovens.

In embodiments of separation systems, the composition of solid stationary phase and mobile phase are selected according to the nature of the analytes or sample to be separated. In an embodiment, a separation system comprises a mobile phase with a constant composition. In an embodiment, a separation system is an isocratic separation. In a further embodiment, the separation system includes a liquid mobile phase of constant composition. In another embodiment, a separation system is a gradient separation wherein the elution strength of the mobile phase changes with time during use of the separation system. In additional embodiments, the elution strength of the mobile phase is modulated by changes in one or more of the following: solvent, temperature, pH, ionic strength or electric field. In a further embodiment, the separation system comprises a liquid mobile phase with a gradient composition. In a still further embodiment, the separation system includes a liquid mobile phase composed of an aqueous to organic solvent gradient.

In an embodiment, separation performance of chromatographic separation units, systems, and methods is described or predicted by calculation of resolution. In an embodiment, the Fundamental Resolution Equation or alternative forms thereof are additionally useful for selection of column dimensions for a given separation. The Fundamental Resolution Equation is provided below:

$$Rs = \frac{\sqrt{N}}{4} \cdot ( α - 1 ) \cdot \frac{{k}^{′}}{{k}^{′} + 1} \qquad Eq . 1$$

In an embodiment, an alternative resolution equation is:

$$Rs = 1.18 * \frac{{tR }_{2} - {tR}_{1}}{{( pw \frac{1}{2} )}_{1} + {( pw \frac{1}{2} )}_{2}} \qquad Eq . 2$$

wherein pw½ is the peak width at half max in minutes and tR is the retention time for each analyte. Further guidance regarding calculation of resolution is available in Snyder, Glajch, and Kirkland, Practical HPLC Method Development, John Wiley & Sons—New York, N.Y. (1988). Application of Equation 1 is presented on page 26. Equation 1 is further used to show the resolution for gradient elution, using k-bar, on page 160. Development of other resolution relationships, including calculation of N (theoretical plates) using pw½ (peaks at half-height), is presented on page 24 of Snyder, Glajch, and Kirkland, Practical HPLC Method Development—Second Edition, John Wiley & Sons—New York, N.Y. (1997).

Calculation of resolution using Equation 2 includes underlying assumptions relating retention time to retention volume that do not apply to separation systems and separation units of the present invention. In an embodiment, a modified equation using retention volumes rather than retention times, shown as Equation 3, provides resolution.

$${Rs}^{*} = 1.18 \frac{{vR}_{2} - {vR}_{1}}{{( pw \frac{1}{2} )}_{1} + {( pw \frac{1}{2} )}_{2}} \qquad Eq . 3$$

wherein pw½ is the peak width at half max in volume (e.g., mL) and vR is the retention volume for each analyte.

In an embodiment, resolution calculations are used to predict separation behavior of a region. In an embodiment, Equation 3 is used to predict separation behavior of a region. In a further embodiment, Equation 3 is used to predict separation behavior of a separation unit. In an embodiment, Equation 3 is used to select length and diameter for separation units for separation of analytes. In an embodiment, the relative lengths of regions are selected to provide the desired separation in each region. In an embodiment, resolution equations are utilized to provide guidance as to selection of the various parameters for chromatographic separation.

In various embodiments and examples, the following parameters, given with their abbreviations, are either directly or indirectly used in calculating resolution of a separation system, unit or region.

D=region diameter (cm)

L=region length (cm)

XA=cross-sectional area of region

F=flow rate of the mobile phase (mL/min)

LV=linear velocity=F·(1/(XA·Por)(cm/min)

dP=particle diameter (μm)

Por=packed bed porosity (%)

H=height equivalent of a theoretical plate (estimated)=2*dP=(μm)

N=theoretical plates=L/(H/10,000 μm/cm)

Vm=mobile-phase volume of region=XA·L·Por=(mL)

t₀=column dead time=Vm/F=mL/(mL/min)=(min)

Ld=total sample load (μg)

tR1=Retention Time of analyte A

tR2=Retention Time of analyte B

k′1=capacity factor of analyte A=(tR1−to)/to

k′2=capacity factor of analyte B=(tR2−to)/to

D, L, and XA are region dimensions. D applies where a region includes solid stationary phase having circular cross-sectional area. In other cases, XA is used. dP and Por are properties of the solid phase material as packed into each region. Flow rate of the mobile phase is selected. The number of theoretical plates and height equivalent thereof are determined in isocratic separations based upon other separation parameters or estimated from the equation H=2 dP.

In an embodiment, improvement in chromatographic separations are demonstrated by comparison of similar chromatographic systems. In an embodiment, comparisons of different chromatographic systems are made by comparison of chromatographic separation of the similar sample under similar mobile and stationary phase identity. In a further embodiment, equivalent chromatographic separation for the purpose of comparison of a separation unit with a single diameter column uses the same overall length of solid stationary phase for each system, similar solid stationary phase composition, similar mobile phase flow rate, and similar mobile phase composition.

The example set forth below describe some of the many possible embodiments of the invention. The examples are not intended to be limiting, as the scope of the invention is defined by the claims.

### EXAMPLE 1

### Predicted Isocratic Separation of Small Molecules

Example 1 demonstrates predicted separation performance using an embodiment of a separation system comprising an embodiment of a separation unit. Example 1 describes various parameters used in operation of separation systems and separation units.

The separation unit of Example 1 comprises two regions. The first region has a diameter of 0.4 cm and length of 5 cm. The second region has diameter of 0.2 cm and length of 5 cm. The general structure of the separation unit analyzed in Example 1 is similar, but not limited to those shown in FIGS. 1 and 2. The predicted separation is based upon both regions containing a solid stationary phase comprising particles averaging 5 μm in diameter with packed bed porosity of 60%. Two analytes, designated A and B, have predetermined k′ (k′ 1 for analyte A and k′2 for analyte B) and α values for the particular analytes and combination of solid stationary phase and mobile phase used. Other selected and calculated parameters are presented in Table 1 below.

Resolution Rs is calculated by equation 1 above. Theoretical plates are estimated as 2 dP for each region. The effective resolution of the separation unit is determined by using N equals plates (N) calculated for region 1 plus plates (N) calculated for region 2.

A comparative example is also provided. In the comparative example, the same two analytes, A and B, as Example 1 are considered. Both systems have a solid stationary phase of particles 5 μm in diameter with packed bed porosity of 60% and an isocratic mobile phase. The comparative example system comprises a column 0.4 cm in diameter and length of 10 cm. Selected and calculated parameters for Comparative Example A are also presented in Table 1.

Comparison of the isocratic separations of Example 1 and comparative Example shows that tR of each of the analytes, A and B, is reduced.

Consequently the run time of the entire separation, to, is reduced by using a separation unit of Example 1. Notably, although the flow rate of the mobile phase into and out of the separation unit is constant, the linear velocity increases in the second region. Hence, the separation unit demonstrates multiple linear velocities within a single separation without changing the flow rate.

With resolution values (Rs) greater than 1 the bulk of each analyte mass is predicted to be in separate bands at time of entry into the second region. By at least partially resolving the analytes before the bands of material migrate into the second region, separation of a larger sample load is predicted without causing overloading related band broadening.

In Example 1, the predicted total run time is reduced as compared to the control column. Furthermore resolution is predicted to be approximately equivalent between Example 1 and the control. Therefore, problems such as increased band broadening or reduction in separation quality are not predicted with use of the separation unit of Example 1. In the predicted cases, an assumption of no loss of theoretical plates was made.

The parameters used in Example 1 may be modified to customize the specific example presented for changes in chromatographic technique, analytes to be separated, changes in mobile phase and or stationary phase, separation of other analytes, and changes in separation unit XA and length.

TABLE 1
Example 1-Separation Unit with two or more regions
C1 [0.4 cm × 5 cm] + C2 [0.2 cm × 5 cm]

| | | | Effective | | Control | |
|---|---|---|---|---|---|---|
| | Region 1 | Region 2 | Parameters for | | column | |
| | Parameters | Parameters | C1 + C2 | | [0.4 cm × 10 cm] | |
| D = | 0.4 | 0.2 | — | cm | 0.4 | cm |
| L = | 5 | 5 | 10 | cm | 10 | cm |
| F = | 1 | 1 | — | mL/min | 1 | mL/min |
| LV = | 13.3 | 53.1 | — | cm/min | 13.3 | cm/min |
| XA = | 0.13 | 0.03 | — | cm² | 0.13 | cm² |
| Ld = | 20.0 | 5.0 | 20.0 | μg | 20.0 | μg |
| dP = | 5 | 5 | — | μm | 5 | μm |
| Por = | 60% | 60% | — | — | 60% | — |
| Vm = | 0.377 | 0.094 | 0.471 | mL | 0.754 | mL |
| tₒ = | 0.377 | 0.094 | 0.471 | min | 0.754 | min |
| tR₁ = | 1 | 0.25 | 1.25 | min | 2 | min |
| tR₂ = | 1.2 | 0.3 | 1.50 | min | 2.4 | min |
| k′₁ = | 1.65 | 1.65 | 1.65 | — | 1.65 | — |
| k′₂ = | 2.18 | 2.18 | 2.18 | — | 2.18 | — |
| H = | 10.0 | 10.0 | 10.00 | μm | 10.0 | μm |
| N = | 5000 | 5000 | 10000 | — | 10000 | — |
| α = | 1.3 | 1.3 | 1.3 | — | 1.3 | — |
| Rs = | 3.5 | 3.5 | 5.0 | — | 5.0 | — |
| BP = | 30 | 120 | 150 | bar | 60 | bar |

** Typical value used for example - system pressure not included.

### EXAMPLE 2

### Predicted Isocratic Separation of Small Molecules

Example 2 describes an embodiment of a separation system. The separation system includes an embodiment of a separation unit having a first region where D=0.46 cm and L=2 cm, and having a second region where D=0.21 cm and L=8 cm. The general structure of the separation unit analyzed in Example 2 is similar, but not limited to the embodiment shown in FIG. 3.

The separation behavior of two analytes, A and B, is predicted in the separation system of Example 2. Both regions contain a solid stationary phase comprising particles averaging 5 μm in diameter with packed bed porosity of 60%. Two analytes, designated A and B, have predetermined k′ (k′ 1 for analyte A and k′2 for analyte B) and α values for the particular analytes and combination of solid stationary phase and mobile phase used. Other selected and calculated parameters are presented in Table 2 below.

Resolution Rs is calculated by equation 1 above. Theoretical plates are estimated as 2 dP for each region. The effective resolution of the separation unit is determined by using N equals plates (N) calculated for region 1 plus plates (N) calculated for region 2, assuming no loss of theoretical plates.

A control system with standard column is also provided. In the control, the same two analytes, A and B, as Example 2 are considered. Both systems have a solid stationary phase of particles 3.51 μm in diameter with packed bed porosity of 60% and an isocratic mobile phase. The control system comprises a column 0.4 cm in diameter and length of 10 cm. Selected and calculated parameters for the control system are also presented in Table 1.

Comparison of the predicted isocratic separations of Example 2 and the control shows that tR of each of the analytes, A and B, is significantly reduced. Consequently the run time of the entire separation is reduced by using a separation unit of Example 2. Notably, although the flow rate of the mobile phase into the separation unit is constant, the linear velocity is predicted to increase in the second region. Hence, the separation unit predicted to have multiple linear velocities within a single separation without changing the flow rate. In Example 2, the combination of a shorter first region with a longer region is predicted to reduce the run time compared to the control column by greater than 60% without change or loss in resolution.

With resolution values (Rs) greater than 1 the bulk of each analyte mass is predicted to be in separate bands at time of entry into the second region. By at least partially resolving the analytes before the bands of material migrate into the second region, separation of a larger sample load is possible without causing overloading related band broadening.

In Example 2, the predicted total run time is reduced as compared to the control column. Furthermore resolution is predicted to be approximately equivalent between Example 2 and the control. Therefore, problems such as increased band broadening or reduction in separation quality are not predicted with use of the separation unit of Example 2. In the predicted cases, an assumption of no loss of theoretical plates was made.

The parameters used in Example 2 may be modified to customize the specific example presented for changes in chromatographic technique, analytes to be separated, changes in mobile phase and or stationary phase, separation of other analytes, and changes in separation unit XA and length.

TABLE 2
Example 2-Separation Unit with two or more regions
C1 [0.46 cm × 2 cm] + C2 [0.21 cm × 8 cm]

| | Region 1 | Region 2 | Effective | | Comparative | |
|---|---|---|---|---|---|---|
| | Param- | Param- | Parameters for | | Example | |
| | eters | eters | C1 + C2 | | [0.46 × 10 cm] | |
| D = | 0.46 | 0.21 | — | cm | 0.46 | cm |
| L = | 2 | 8 | 10 | cm | 10 | cm |
| F = | 1 | 1 | 1 | mL/min | 1 | mL/min |
| LV = | 10.0 | 48.1 | — | cm/min | 10.0 | cm/min |
| XA = | 0.17 | 0.03 | — | cm² | 0.17 | cm² |
| Ld = | 20.0 | 4.2 | 20.0 | μg | 20.0 | μg |
| dP = | 3.5 | 3.5 | — | μm | 3.5 | μm |
| Por = | 60% | 60% | — | — | 60% | — |
| Vm = | 0.199 | 0.166 | 0.366 | mL | 0.997 | mL |
| to = | 0.199 | 0.166 | 0.366 | min | 0.997 | min |
| tR₁ = | 0.356 | 0.297 | 0.653 | min | 1.78 | min |
| tR₂ = | 0.460 | 0.384 | 0.84 | min | 2.30 | min |
| k′₁ = | 0.79 | 0.79 | 0.79 | — | 0.79 | — |
| k′₂ = | 1.31 | 1.31 | 1.31 | — | 1.31 | — |
| H = | 7.0 | 7.0 | 7.00 | μm | 7.0 | μm |
| N = | 2857 | 11429 | 14286 | — | 14286 | — |
| α = | 1.7 | 1.7 | 1.7 | — | 1.7 | — |
| Rs = | 3.9 | 7.8 | 8.8 | — | 8.8 | — |
| BP** = | 16 | 315 | 331 | bar | 82 | bar |

****Typical value used for example - system pressure not included.

### EXAMPLE 3

### Isocratic Separation of Small Molecules

In Example 3, an embodiment of a separation system including a separation unit embodiment is used to perform an isocratic separation by HPLC of four small molecules. The separation unit comprises a first region having a diameter of 4.6 mm and length of 50 mm and a second region having a diameter of 2.1 mm and length of 50 mm. The separation unit is in multicolumn configuration, wherein each region is an individual column connected in series. Two control systems/columns, control A and control B were also ran. Control A includes a column having a diameter of 4.6 mm and length of 100 mm. Control B includes a column having a diameter of 4.6 mm and length of 50 mm.

The individual columns used for first region and second region of the separation unit of Example 3 and the controls are Zorbax® 300SB-C18 columns commercially available from Agilent Technologies. The Zorbax® 300SB-C18 columns are suitable for reversed phase HPLC. The solid stationary phase material has an average particle size of 3.5 cm. The mobile phase is 60% acetonitrile (ACN) 40% water. The flow rate is 1 mL/min.

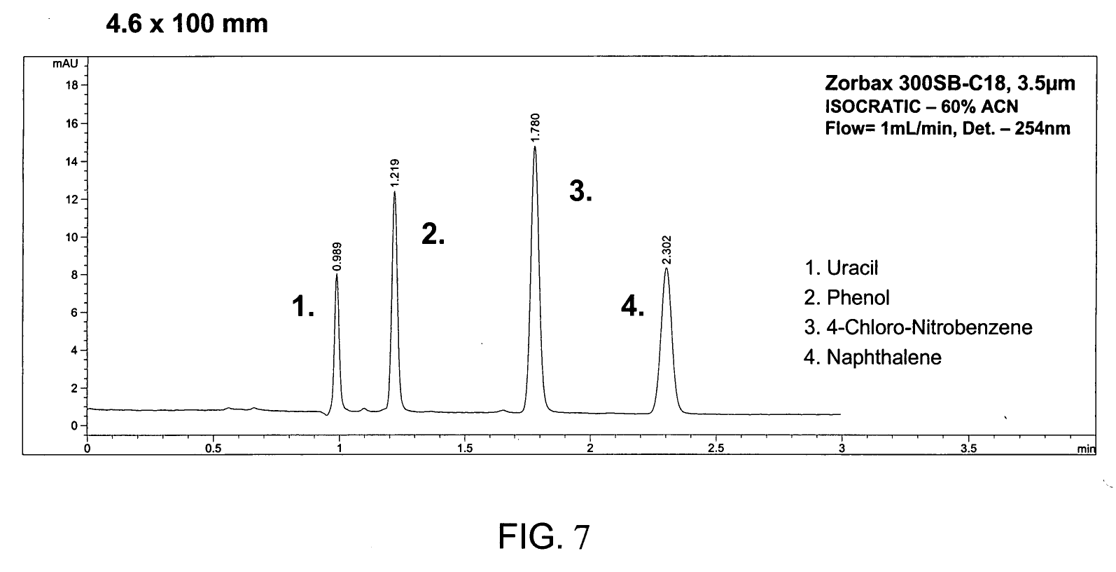

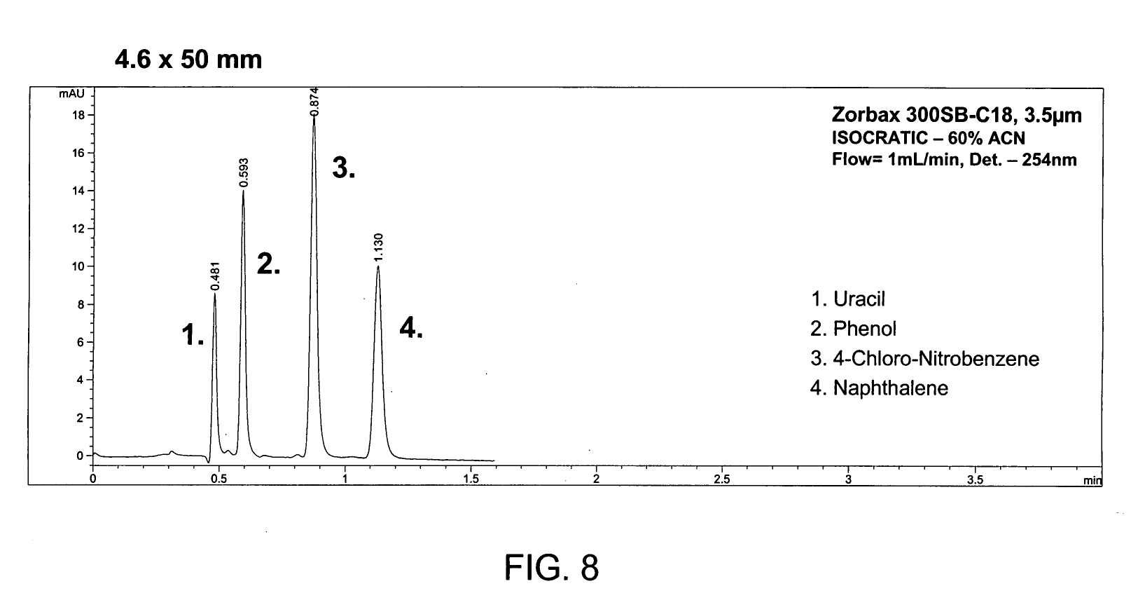

The sample contains uracil, phenol, 4-chloro-nitrobenzene, and naphthalene. The chromatogram for the separation by the separation system and unit of Example 3 is presented in FIG. 6. The chromatogram for Control A is presented in FIG. 7. The chromatogram for Control B is presented in FIG. 8. Data and calculations, including resolution, for the separation system of Example 3 and control columns A and B is presented in Table 3. The elution order seen in the chromatograms and Table 3 is peak 1—uracil, peak 2—phenol, peak 3—4-chloro-nitrobenzene, and peak 4—naphthalene.

Resolution for the separation unit is calculated from Equation 3 above. Rs* are calculated from vR (retention volume) to adjust for reduced tR (retention time in second region. vR is calculated from tR for the separation unit of Example 3 according to the derivation provided in Equations 4-10 below. Equations 4-10 consider a separation unit embodiment of 2 regions, 1 and 2, of equal length, wherein region 1 has a diameter of 4.6 mm and region 2 has a diameter of 2.1 mm. Equations 4-10 are adapted for use with other separation units embodiments.
tR=½(vR/F)+½(((2.1)²)/((4.6)²))(vR/F) Eq. 4
vR=tR/(½+(½×(((2.1)²)/((4.6)²))))) Eq. 5
vR/F=tR/(½+(½× 1/4.8)) Eq. 6
vR/F=tR/(½+ 1/9.6)=tR/( 4.8/9.6+ 1/9.6) Eq. 7
vR/F=tR/( 5.8/9.6)=tR× 9.6/5.8 Eq. 8
vR=tR× 9.6/5.8×F Eq. 9
if F=1 mL/min then vR=tR× 9.6/5.8 Eq. 10
Resolution (Rs) for control systems is calculated according Equation 2.

Comparison of the isocratic separation of Example 3 with Control A and Control B shows α and k′ is approximately constant for all three systems, while total retention time is reduced. One advantage is that quality of separation of the analytes is not adversely affected. In fact, pw½ goes down for the separation system of Example 3, indicating peak narrowing rather than undesired peak broadening. Another advantage is reduction in total run time and tR for all four analytes is reduced for Example 3. The separation system and separation unit demonstrate equivalent separation of the analytes with a reduction in total run time as compared to the control systems. The data of Example 3 closely corresponds with the separation predicted for the system.

TABLE 3
Example 3-Separation Unit with two regions:

| C1 [4.6 mm × 50 mm] + C2 [2.1 mm × 50 mm] | | | | | | | |
|---|---|---|---|---|---|---|---|
| Peak | tR | | | pw1/2 | | | to = 0.593 |
| # | (min) | vR | k′ | (min) | α | Rs* | 258 bar |
| 1 | 0.593 | 0.982 | 0.00 | 0.0181 | — | | — |
| 2 | 0.724 | 1.198 | 0.22 | 0.0208 | — | 6.6 | — |
| 3 | 1.058 | 1.751 | 0.78 | 0.0286 | 3.55 | 13.2 | — |
| 4 | 1.369 | 2.266 | 1.31 | 0.036 | 1.67 | 9.4 | — |

| Control A-4.6 × 100 mm | | | | | | | |
|---|---|---|---|---|---|---|---|
| Peak | tR | | | pw1/2 | | | to = 0.989 |
| # | (min) | | k′ | (min) | α | Rs | 82 bar |
| 1 | 0.989 | — | 0.00 | 0.02 | — | — | — |
| 2 | 1.219 | — | 0.23 | 0.0242 | — | 6.1 | — |
| 3 | 1.78 | — | 0.80 | 0.0368 | 3.44 | 10.9 | — |
| 4 | 2.302 | — | 1.33 | 0.0472 | 1.66 | 7.3 | — |

| Control B-4.6 × 50 mm | | | | | | | |
|---|---|---|---|---|---|---|---|
| Peak | tR | | | pw1/2 | | | to = 0.48 |
| # | (min) | | k′ | (min) | α | Rs | 65 bar |
| 1 | 0.48 | — | 0.00 | 0.0169 | — | — | — |
| 2 | 0.593 | — | 0.24 | 0.0194 | — | 3.7 | — |
| 3 | 0.874 | — | 0.82 | 0.0269 | 3.49 | 7.2 | — |
| 4 | 1.13 | — | 1.35 | 0.0342 | 1.65 | 4.9 | — |

The parameters used in Example 3 may be modified to customize the specific example presented for changes in chromatographic technique, analytes to be separated, changes in mobile phase and or stationary phase, separation of other analytes, and changes in separation unit, including region XA and length.

### EXAMPLE 4

### Gradient Separation of Small Molecules

In Example 4, an embodiment of a separation system including a separation unit embodiment is used to perform a gradient separation by HPLC of four small molecules. The separation unit comprises a first region having a diameter of 4.6 mm and length of 50 mm and a second region having a diameter of 2.1 mm and length of 50 mm. The separation unit is in multicolumn configuration, wherein each region is an individual column connected in series. A control system was used to perform a comparable separation. The control system includes a column having a diameter of 4.6 mm and length of 100 mm.

The individual columns used for first region and second region of the separation unit of Example 4 and the control are Zorbax® 300SB-C18 columns commercially available from Agilent Technologies. The solid stationary phase material has an average particle size of 3.5 μm. The mobile phase is a gradient of 40% acetonitrile (ACN)/60% water increasing over a period of 5 minutes (period for separation) to 60% acetonitrile (ACN)/40% water. The flow rate is 1 mL/min.

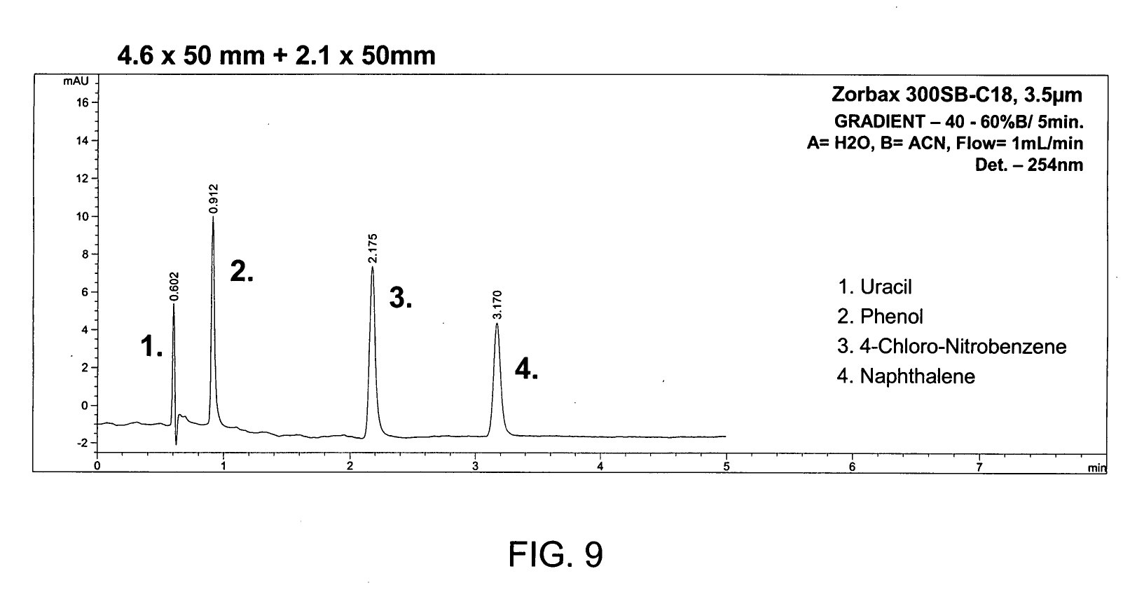

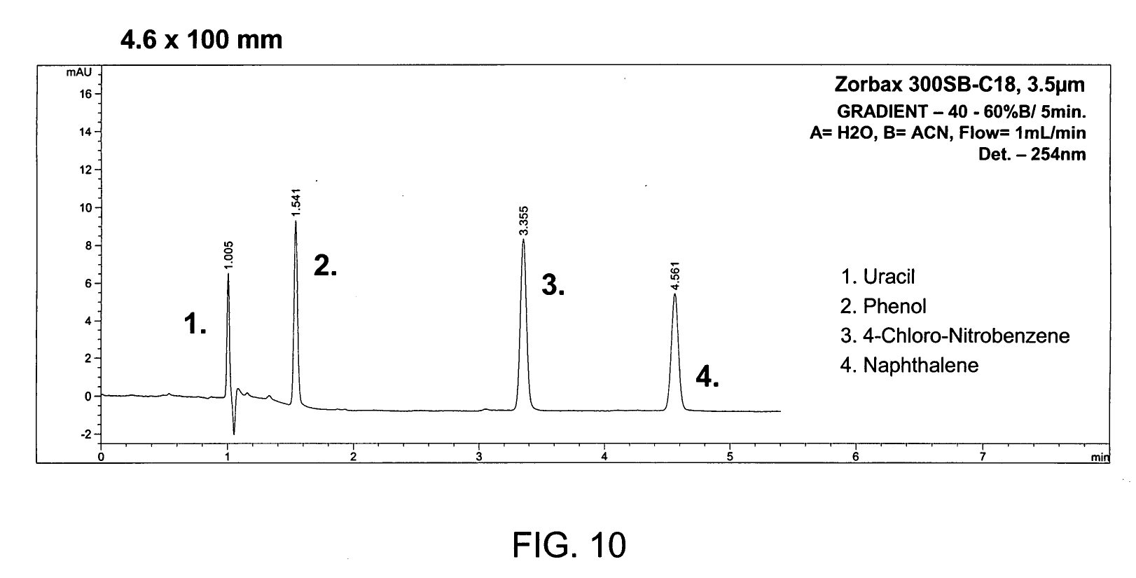

The sample contains uracil, phenol, 4-chloro-nitrobenzene, and naphthalene. The chromatogram for the separation by the separation system and unit of Example 4 is presented in FIG. 9. The chromatogram for the control is presented in FIG. 10. Data and calculations, including resolution, for the separation system of Example 4 and the control are presented in Table 4. The elution order seen in the chromatograms and Table 4 is peak 1—uracil, peak 2—phenol, peak 3—4-chloro-nitrobenzene, and peak 4—naphthalene.

Resolution (Rs*) is calculated from Equation 3 above. Rs* are calculated from vR (retention volume) to adjust for reduced tR (retention time in second region). vR is calculated from tR for the separation unit of Example 4 according to Equation 3 and the derivation provided in Equations 4-10 provided above. Resolution (Rs) for the control is calculated from Equation 2.

Comparison of the gradient separation of the small molecules by the separation unit of Example 4 with the control column shows one advantage is increased retention volume and another advantage is increased resolution (calc. from v_{R}). Another advantage is reduced pw½ indicating reduced band broadening. Another advantage is a decrease in total run time.

TABLE 4

| Separation Unit: 4.6 × 50 mm + 2.1 × 50 mm | | | | | | | |
|---|---|---|---|---|---|---|---|
| Peak | tR | | | pw1/2 | | | to = 0.602 |
| # | (min) | vR | k′ | (min) | α | Rs* | 318-270 bar |
| 1 | 0.602 | 0.996 | 0.00 | 0.0175 | — | — | — |
| 2 | 0.912 | 1.510 | 0.51 | 0.026 | — | 13.9 | — |
| 3 | 2.175 | 3.600 | 2.61 | 0.0493 | 5.07 | 32.8 | — |
| 4 | 3.71 | 6.141 | 5.16 | 0.0603 | 1.98 | 27.4 | — |

| Control column: 4.6 × 100 mm | | | | | | | |
|---|---|---|---|---|---|---|---|
| Peak | tR | | | pw1/2 | | | to = 1.005 |
| # | (min) | | k′ | (min) | α | Rs | 99-84 bar |
| 1 | 1.005 | — | 0.00 | 0.0205 | — | — | — |
| 2 | 1.541 | — | 0.53 | 0.0314 | — | 12.2 | — |
| 3 | 3.355 | — | 2.34 | 0.0527 | 4.38 | 25.5 | — |
| 4 | 4.561 | — | 3.54 | 0.0611 | 1.51 | 12.5 | — |

Run conditions: Gradient mobile phase: A = water (H₂0), B = acetonitrile (ACN), F = 1 mL/min, 40%-60% B/per 5 minutes.

The parameters used in Example 4 may be modified to customize the specific example presented for changes in chromatographic technique, analytes to be separated, changes in mobile phase and or stationary phase, separation of other analytes, and changes in separation unit, including XA and length of each region.

### EXAMPLE 5

### Gradient Separation of Biomolecules

In an embodiment, the properties of the analytes in a sample are well-suited for chromatographic separation under conditions of large V_{G} to Vm ratios and large k*. V_{G} is gradient time×flow rate and Vm is the separation unit dead volume. These analytes are large molecules that have very large S values, such as biomolecules (proteins and nucleic acids, etc . . . ). With a large S-value, k* is increased (See Equation 1 above) in a manner that does not reduce the number of theoretical plates, N. In addition, a molecule with a large S-value has a steep elution curve; in plots of k* vs. organic concentration, k* drops very sharply when organic is increased. The result is that large molecules tend to elute as discrete sharp bands in mobile phase gradients even when there are separated under conditions of relatively low theoretical plates.

In Example 5, an embodiment of a separation system including a separation unit embodiment is used to perform a gradient separation by HPLC of nine large molecules. The molecules for this example are biological molecules of various sizes (large and small molecules) including: Gly-Tyr, Val-Tyr-Val, Met-enkephalin, Leu-enkephalin, Angiotensin II, RNase A, Cytochrome C, Holotransferrin, and Apomyoglobin.

The separation unit of Example 5 comprises a first region having a diameter of 4.6 mm and length of 50 mm and a second region having a diameter of 2.1 mm and length of 50 mm. The separation unit is in multicolumn configuration, wherein each region is an individual column connected in series. A control system, including a column having a diameter of 4.6 mm and length of 100 mm was used to perform a comparable separation of the nine biomolecules.

The individual columns and solid stationary phase used for first region and second region of the separation unit of Example 5 and the control are Zorbax® 300SB-C18 columns commercially available from Agilent Technologies. The solid stationary phase material had an average particle size of 3.5 μm. The mobile phase was a gradient of 0-100% acetonitrile (ACN)/water over 40 minutes. The flow rate was 0.5 mL/min.

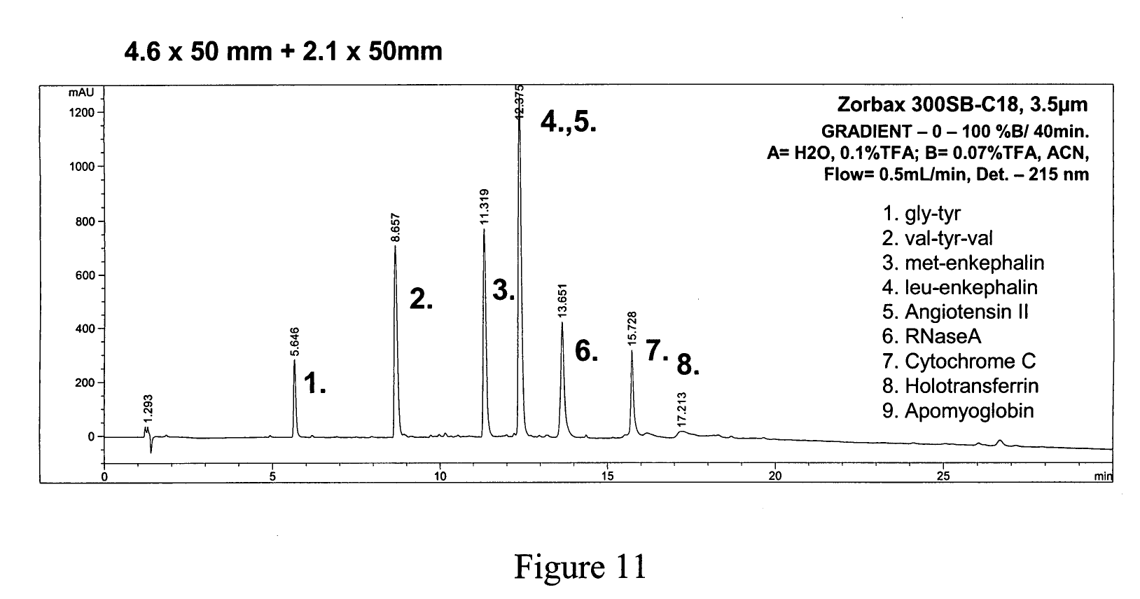

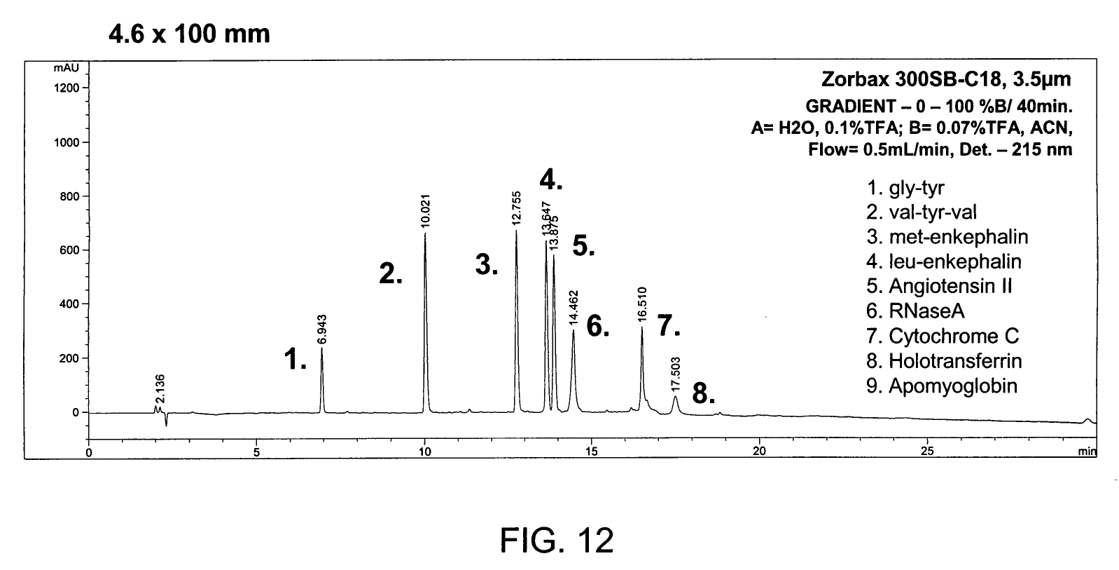

The chromatogram for the separation by the separation system and unit of Example 5 is presented in FIG. 11. The chromatogram for the control is presented in FIG. 12. Data and calculations, including resolution, for the separation system of Example 5 and the control are presented in Table 5. The elution order seen in the chromatograms and Table 4 is peak 1—Gly-Tyr, peak 2—Val-Tyr-Val, peak 3—Met-enkephalin, peak 4—Leu-enkephalin, peak 5—Angiotensin II, peak 6—RNase A, peak 7—Cytochrome C, peak 8—Holotransferrin, and peak 9—Apomyoglobin.

Resolution is calculated from Equation 2 above. Rs* are calculated from vR (retention volume) to adjust for reduced tR (retention time in second region. vR is calculated from tR for the separation unit of Example 5 according to the derivation provided in Equations 4-10 provided above.

Comparison of the gradient separation of the biomolecules of Example 5 with the control column shows one advantage is increased retention volume and another advantage is increased resolution (calc. from v_{R}). Another advantage is a decrease in total run time.

Peak 8 has unusually poor peak shape with decreased resolution between it and the following peak. It is typical to get poor peak shape on larger proteins, particularly those that are later eluting. Improved separation of peak 8 may be achieved by running the separation system at an elevated temperature. Fine tuning of the separation to further optimize performance for all compounds is achievable by changing parameters including, but not limited to: modifying (e.g., increasing) run temperature, modifying mobile phase composition, and modifying flow rate.

TABLE 5

| Separation Unit: 4.6 × 50 + 2.1 × 50 mm | | | | | | F = 0.5 | | to = 1.293 |
|---|---|---|---|---|---|---|---|---|
| Peak # | tR (min) | vR | k′ | pw1/2 (min) | pw1/2 (mL) | α | Rs* | 318-270 bar |
| 1 | 5.646 | 9.345 | 3.37 | 0.0685 | 0.03425 | — | — | — |
| 2 | 8.657 | 14.329 | 5.70 | 0.101 | 0.0505 | — | 34.7 | — |
| 3 | 11.319 | 18.735 | 7.75 | 0.092 | 0.046 | 1.36 | 26.9 | — |
| 4 | 12.375 | 20.483 | 8.57 | 0.095 | 0.0475 | 1.11 | 11.0 | — |
| 5 | 12.375 | 20.483 | 8.57 | 0.095 | 0.0475 | 1.00 | 0.0 | — |
| 6 | 13.651 | 22.595 | 9.56 | 0.0997 | 0.04985 | 1.12 | 12.8 | — |
| 7 | 15.728 | 26.033 | 11.16 | 0.075 | 0.0375 | 1.17 | 23.2 | — |
| 8 | 17.213 | 28.490 | 12.31 | 0.39 | 0.195 | 1.10 | 6.2 | — |
| 9 | 26.667 | 44.138 | 19.62 | 0.167 | 0.0835 | 1.59 | 33.2 | — |

| Control Column: 4.6 × 100 mm | | | | | | F = 0.5 | | to = 2.136 |
|---|---|---|---|---|---|---|---|---|
| Peak # | tR (min) | | k′ | pw1/2 (min) | pw1/2 (mL) | α | Rs | 99-84 bar |
| 1 | 6.943 | — | 2.25 | 0.0596 | 0.0298 | — | — | — |
| 2 | 10.021 | — | 3.69 | 0.0757 | 0.03785 | — | 26.8 | — |
| 3 | 12.755 | — | 4.97 | 0.073 | 0.0365 | 1.35 | 21.7 | — |
| 4 | 13.647 | — | 5.39 | 0.076 | 0.038 | 1.08 | 7.1 | — |
| 5 | 13.875 | — | 5.50 | 0.074 | 0.037 | 1.02 | 1.8 | — |
| 6 | 14.462 | — | 5.77 | 0.105 | 0.0525 | 1.05 | 3.9 | — |
| 7 | 16.51 | — | 6.73 | 0.062 | 0.031 | 1.17 | 14.5 | — |
| 8 | 17.503 | — | 7.19 | 0.15 | 0.075 | 1.07 | 5.5 | — |
| 9 | 29.73 | — | 12.92 | 0.171 | 0.0855 | 1.80 | 44.9 | — |

Run conditions for Separation Unit and control: Gradient mobile phase: A = water (H₂0), B = acetonitrile (ACN), F = 0.5 mL/min, 40%-60% B/per 5 minutes.

The parameters used in Example 5 may be modified to customize the specific example presented for changes in chromatographic technique, analytes to be separated, changes in mobile phase and or stationary phase, separation of other analytes, and changes in separation unit size and shape.

All publications and patent applications in this specification are indicative of the level of ordinary skill in the art to which this invention pertains and are incorporated herein by reference in their entireties.

The invention has been described with reference to various specific and preferred embodiments and techniques. However, it should be understood that many variations and modifications may be made while remaining within the spirit and scope of the invention.

The claimed invention is:

1. A system for chromatographic separation of two or more components of a sample, the system comprising:
a separation unit containing solid stationary phase, the separation unit comprising:
two or more regions connected in series;
each region, having a uniform cross-sectional area, and
at least each region comprising a cross-sectional area different from the cross-sectional area of at least one adjacent region.

2. The system of claim 1, wherein two or more regions of different cross-sectional area comprising a column comprising two or more contiguous regions, each region with uniform cross-sectional area that differs from the cross-sectional area of adjacent regions.

3. The system of claim 1, wherein two or more regions of different cross-sectional area comprising connecting two or more separate columns, each column having uniform cross-sectional area that differs from the cross-sectional area of adjacent columns.

4. The system of claim 1, wherein the separation unit comprises a first region having cross-sectional area X and a second region having cross-sectional area Y, wherein X is greater than Y.

5. The system of claim 1, additionally comprising a mobile phase that flows through the solid stationary phase, wherein the mobile phase comprises a gradient of elution strength.

6. The system of claim 1, additionally comprising a mobile phase that flows through the solid stationary phase, wherein the mobile phase comprises a solvent for isocratic elution.

7. The system of claim 1, wherein at least one region contains solid stationary phase of smaller size than solid stationary phase contained in at least one adjacent region.

8. The system of claim 1, wherein the components of the sample to be separated are biological molecules having large S values.

9. The system of claim 1, wherein the regions of the solid stationary phase have the same length.

10. The system of claim 1, wherein at least one region of the solid stationary phase is shorter than at least one adjacent region of the solid stationary phase.

11. The system of claim 1, wherein at least one region of the solid stationary phase is longer than at least one adjacent region of the solid stationary phase.

12. The system of claim 1, wherein the separation unit is comprised within a microfluidic device.

13. A method for improving separation of sample components in a chromatographic system, the system comprising a solid stationary phase and a mobile phase, the method comprising:
flowing mobile phase through the solid stationary phase;
applying a sample containing two or more components for separation to a solid stationary phase, wherein the solid stationary phase comprises a first stationary phase region having a cross-sectional area X and a second stationary phase region having a cross-sectional area Y, wherein cross-sectional area X is not equal to cross-sectional area Y;
separating components by interaction with the flowing mobile phase through the first stationary phase region; and
moving each component into the second stationary phase region of the solid stationary phase for further separation;
thereby improving the separation of two or more components of the sample.

14. The method of claim 13, wherein cross-sectional area X is greater than cross-sectional area Y.

15. The method of claim 13, wherein the second region of cross-sectional area Y contains solid chromatographic particles of smaller size than solid chromatographic particles contained in the first region of cross-sectional area X.

16. The method of claim 13, wherein a component elutes through the second stationary phase region of the solid stationary phase at a higher linear velocity than movement through the first stationary phase region, thereby achieving separation with reduced run time.

17. The method of claim 13, wherein a component elutes through the second stationary phase region of the solid stationary phase at a higher rate than movement through the first stationary phase region, thereby improving separation with increased resolution.

18. The method of claim 13, wherein the chromatographic system is a gas chromatography system, liquid chromatography system, high pressure liquid chromatography system, supercritical fluid chromatography, open-face chromatography, capillary electrochromatography, microfluidic device, or detection cell.

19. A separation unit containing a solid stationary phase for chromatographic separation, the separation unit comprising two or more contiguous regions, wherein each region has a unique cross-sectional area.

20. The separation unit of claim 19, wherein the separation unit comprises at least a first region and a second region, wherein the first region of the separation unit has a cross-sectional area X, and the second region of the separation unit has a cross-sectional area Y, wherein X is greater than Y.
